(19) United States
(12) Patent Application Publication
(10) Pub. No.: US 2020/0291972 A1
(43) Pub. Date: Sep. 17, 2020

(54) PASSIVE DE-AERATION BARRIER FOR FLUID CHAMBER

(71) Applicant: Schaeffler Technologies AG & Co. KG, Herzogenaurach (DE)

(72) Inventor: Bradley Bergsma, Windsor (CA)

(73) Assignee: Schaeffler Technologies AG & Co. KG, Herzogenaurach (DE)

(21) Appl. No.: 16/352,017

(22) Filed: Mar. 13, 2019

(51) Int. Cl. F15B 21/044; B01F 5/04; B01D 19/00; F16N 39/00

(52) U.S. Cl. CPC F15B 21/044; B01F 5/0403; B01D 2221/08; F16N 39/002; B01D 19/0057

(57) ABSTRACT

A fluid chamber assembly is disclosed that includes a housing defining at least one de-aeration opening, and a barrier within the housing that divides an interior of the housing into a first chamber and a second chamber. The barrier includes at least one perforation. The barrier can have a curved profile. The at least one perforation can include multiple perforations. The at least one perforation can have a conical profile.

### FIELD OF INVENTION

The present invention relates to a fluid housing and more specifically directed to a de-aeration feature for a fluid housing.

### BACKGROUND

Oil or hydraulic fluid actuators are used in a wide variety of applications. One type of existing hydraulic fluid actuator is a UniAir® system, which controls the opening and closing of engine valves. In all hydraulic fluid actuator systems, it is desirable to reduce aeration of the associated fluid as much as possible, since aerated fluid results in unpredictable levels of lift loss and valve opening delays.

One known solution for reducing aeration in fluid is to provide a single de-aeration vent opening, such as a bleed hole, in a portion of the actuator housing, such as a cover. This solution encourages bubbles in the hydraulic fluid to rise up and release through the de-aeration vent opening. However, this solution is only effective when the vehicle is on relatively level ground, and any tilting of the vehicle greatly reduces the effectiveness of this solution.

It would be desirable to provide a de-aeration configuration for a fluid housing assembly that is effective for vehicles that are on uneven surfaces or otherwise tilted.

### SUMMARY

A fluid chamber assembly is disclosed that includes a housing defining at least one de-aeration opening, and a barrier within the housing that divides an interior of the housing into a first chamber and a second chamber. The barrier includes at least one perforation.

In one embodiment, the barrier has a curved profile. In one embodiment, the barrier has a convex profile that defines an apex inwards with respect to the first chamber. The apex can crest in a direction towards the at least one de-aeration opening.

In one embodiment, the at least one de-aeration opening is provided on a surface of the housing that partially defines the first chamber.

The at least one perforation can include a plurality of perforations spaced apart from each other in a pattern. In one embodiment, the at least one perforation has a conical profile.

The fluid chamber assembly is configured to be installed in a vehicle, such that the first chamber defines an upper chamber and the second chamber defines a lower chamber. A fluid inlet is defined on a bottom surface of the housing and the at least one de-aeration opening is defined on an opposite, top surface of the housing. The barrier is curved upwards towards the at least one de-aeration opening and away from the fluid inlet. In one embodiment, a switching solenoid valve inlet is defined on the bottom surface of the housing.

In another embodiment, a fluid chamber assembly is disclosed that includes a medium pressure chamber defining at least one de-aeration opening, and a barrier within the medium pressure chamber that divides the housing into an upper chamber and a lower chamber. The barrier defines a plurality of perforations each having a conical profile, and the barrier has a curved profile that is convex towards the upper chamber. The upper chamber is connected to the at least one de-aeration opening, and the lower chamber is connected to a fluid inlet and a solenoid switching valve inlet that is connected to a high pressure chamber.

A method of supplying de-aerated fluid to a switching solenoid valve via a fluid chamber assembly is provided. The method includes providing a fluid chamber assembly including a housing defining an interior and at least one de-aeration opening. The method includes positioning a barrier within the interior of the housing to divide the interior into first chamber and a second chamber. The barrier defines at least one perforation, and the second chamber is connected to a fluid inlet and a switching solenoid valve inlet. The method includes supplying fluid to the second chamber via the fluid inlet. The method includes de-aerating the fluid via passage of air bubbles through the at least one perforation and out of the at least one de-aeration opening. The method includes supplying de-aerated fluid to the switching solenoid valve inlet.

Additional embodiments are disclosed herein.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1A is top view of a fluid chamber assembly.

FIG. 1B is a cross-sectional view of the fluid chamber assembly along line 1B-1B in FIG. 1A.

FIG. 1C is a magnified view of a portion of the fluid chamber assembly of FIGS. 1A and 1B.

FIG. 2A is a magnified view of a barrier within a housing of a fluid chamber assembly.

FIG. 2B is a top perspective view of the barrier within the housing of FIG. 2A.

FIG. 3A is a side view of a portion of the barrier of FIGS. 2A and 2B.

FIG. 3B is a top view of the barrier of FIG. 3A.

### DETAILED DESCRIPTION OF THE PREFERRED EMBODIMENTS

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

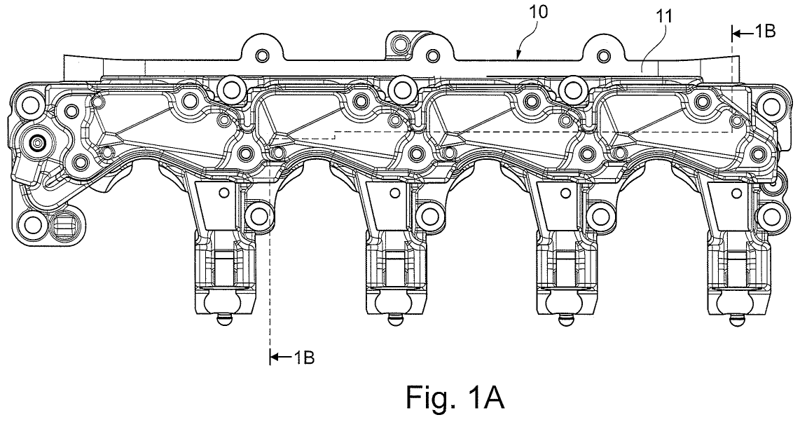

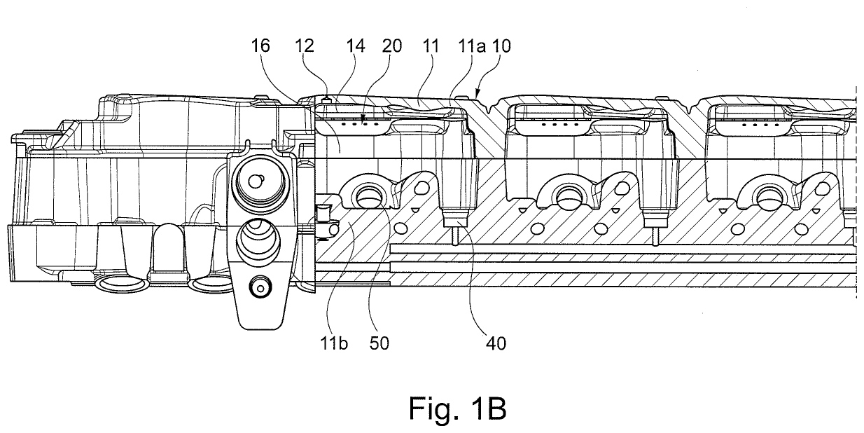

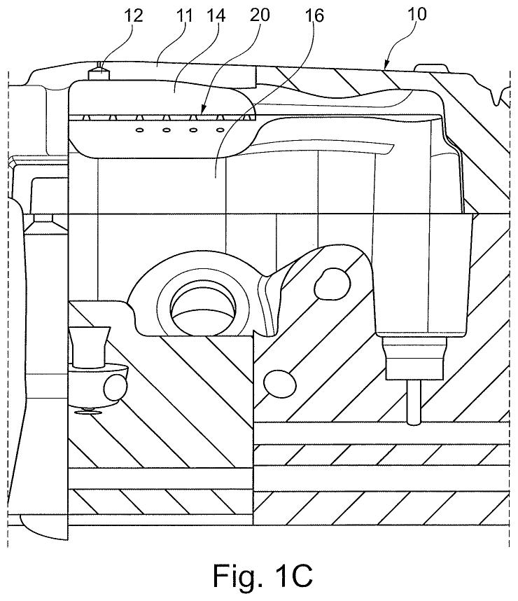

Referring to FIGS. 1A-1C, a fluid chamber assembly 10 is generally illustrated. The fluid chamber assembly 10 is used to provide oil or hydraulic fluid to actuators. Fluid supplied to the fluid chamber assembly 10 (via fluid inlet 40) can have some degree of aeration, which is undesirable. Accordingly, fluid within the fluid chamber assembly 10 should be de-aerated as much as possible before being supplied to associated actuators (via switching solenoid valve inlet 50).

The fluid chamber assembly 10 includes at least one de-aeration opening 12 on a top surface of a housing 11. This de-aeration opening 12 functions as a bleed hole and allows air bubbles to escape the housing 11 and promotes de-aeration of the fluid therein. The de-aeration opening 12 is provided on a surface of the housing 11 that partially defines the first chamber 14 (i.e. the upper chamber). The housing 11 is also known as a medium pressure chamber.

A barrier 20, also known as a gravitational flow separator, is installed within the housing 11 that further promotes de-aeration. The barrier 20 divides an interior of the housing 11 into a first chamber 14 (i.e. the upper chamber) and a second chamber 16 (i.e. the lower chamber). The barrier 20 includes at least one perforation 22. The perforation 22 further promotes de-aeration of the fluid within the housing 11. Air bubbles within the fluid generally tend to stick or adhere to the barrier 20 due to surface tension, and the air bubbles will be pushed upwards through the barrier 20 via the perforation 22 due to curvature of the barrier 20 and due to gravity and buoyancy. Accordingly, air bubbles are urged out of the second chamber 16 and into the first chamber 14, which is desirable since the second chamber 16 holds the fluid prior to being used in associated actuators via the switching solenoid valve inlet 50. As shown in the embodiment of FIG. 1B, the first chamber 14 is smaller than the second chamber 16.

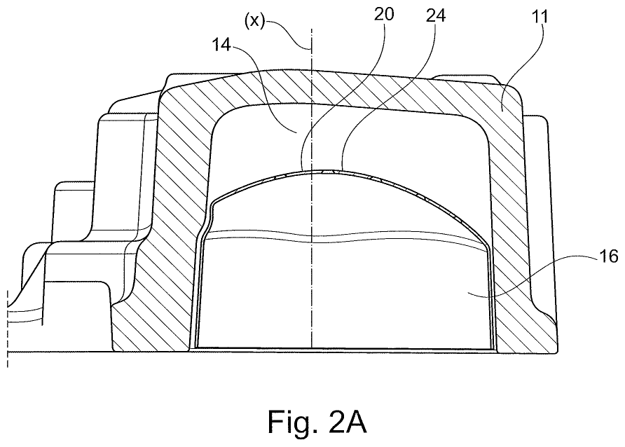

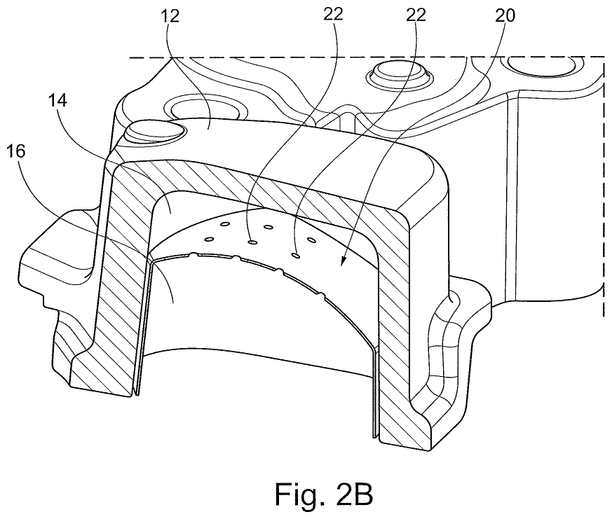

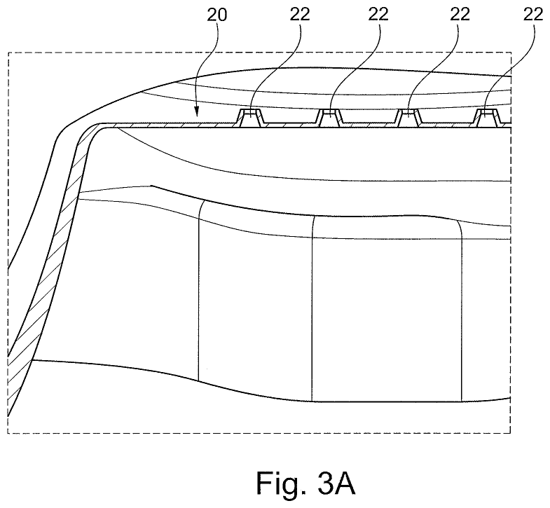

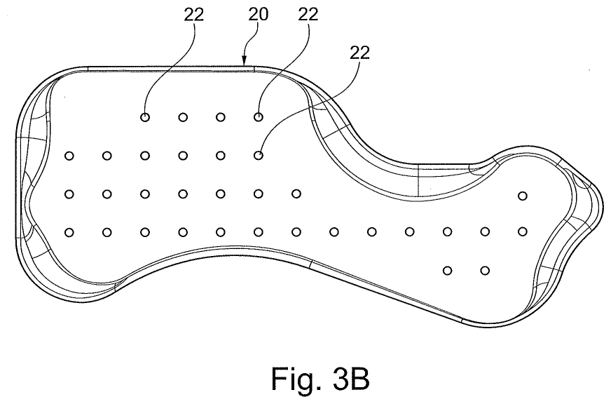

In one embodiment, the barrier 20 has a curved profile. The curved profile further promotes air bubbles to be directed upwards from the second chamber 16 to the first chamber 14 and eventually out of the de-aeration opening 12. The barrier 20 can have a convex profile defining an apex 24 inwards with respect to the first chamber 14. The apex 24 crests in a direction towards the de-aeration opening 12 to promote de-aeration and urging air bubbles in a direction of the de-aeration opening 12. The perforation 22 preferably includes a plurality of perforations 22, as shown in FIGS. 2B, 3A, and 3B, to further promote de-aeration. In one embodiment, the perforations 22 include at least twenty perforations 22, and can include at least thirty perforations 22.

As shown in FIG. 3A, the perforations 22 have a conical profile, with a wider opening facing the second chamber 16 and a narrower opening facing the first chamber 14. This tapered profile further promotes de-aeration by urging air bubbles from the second chamber 16 into the first chamber 14. One of ordinary skill in the art would understand that alternative profiles could be used for the perforation 22.

As shown in FIG. 1B, the fluid inlet 40 is defined on a bottom surface 11b of the housing 11 and the de-aeration opening 12 is defined on an opposite, top surface 11a of the housing 11. The barrier 20 is curved upwards towards the de-aeration opening 12 and away from the fluid inlet 40. The switching solenoid valve inlet 50 is defined on the bottom surface 11b of the housing 11.

In one embodiment, shown in FIG. 2B, a diameter of the at least one perforation 22 is greater than a diameter of the at least one de-aeration opening 12.

The embodiments disclosed herein generally provide effective de-aeration regardless of whether an associated vehicle including the fluid chamber assembly 10 is on level ground or tilted. The barrier 20 provides passive de-aeration of fluid within the housing 11 and achieves de-aeration of the fluid without the use of centrifugal forces or other active means.

The embodiments disclosed herein provide effective de-aeration of fluid in the housing 11 even if the housing 11 is tilted relative to a central axis (X) (illustrated in FIG. 2A) by at least 20 degrees-28 degrees, and more preferably of at least 24 degrees.

Effective de-aeration of fluid, as used herein, is defined as fluid entering the switching solenoid valve inlet 50 contains less than 4% of air, and more preferably contains less than 2% of air.

The barrier 20 can be shaped such that it can be press-fit or installed into a wide range of shapes and configurations of housings 11. The barrier 20 is preferably formed from stamped sheet metal. The barrier 20 can be perforated to form the perforations 22 via any stamping or punching tool.

A method of supplying de-aerated fluid to a switching solenoid valve via a fluid chamber assembly 10 is provided. The method includes providing a fluid chamber assembly 10 including a housing 11 defining an interior and at least one de-aeration opening 12. The method includes positioning a barrier 20 within the interior of the housing 11 to divide the interior into first chamber 14 and a second chamber 16. The barrier 20 defines at least one perforation 22, and the second chamber 16 is connected to a fluid inlet 40 and a switching solenoid valve inlet 50. The method includes supplying fluid to the second chamber 16 via the fluid inlet 40. The method includes de-aerating the fluid via passage of air bubbles through the at least one perforation 22 and out of the at least one de-aeration opening 12. The method includes supplying de-aerated fluid to the switching solenoid valve inlet 50.

Although inlet 50 is described as a switching solenoid valve inlet, one of ordinary skill in the art would recognize that the de-aerated fluid could be provided to any conduit directed to any type of fluid based actuating mechanism.

Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

### LOG OF REFERENCE NUMERALS

fluid chamber assembly 10

housing 11

top surface of housing 11a

bottom surface of housing 11b

de-aeration opening 12

first chamber 14

second chamber 16

barrier 20

perforation 22

apex 24

fluid inlet 40

switching solenoid valve inlet 50

What is claimed is:

1. A fluid chamber assembly comprising:
a housing defining at least one de-aeration opening; and
a barrier within the housing that divides an interior of the housing into a first chamber and a second chamber, the barrier including at least one perforation.

2. The fluid chamber assembly of claim 1, wherein the barrier has a curved profile.

3. The fluid chamber assembly of claim 1, wherein the barrier has a convex profile defining an apex inwards with respect to the first chamber.

4. The fluid chamber assembly of claim 3, wherein the apex crests in a direction towards the at least one de-aeration opening.

5. The fluid chamber assembly of claim 1, wherein the at least one de-aeration opening is provided on a surface of the housing that partially defines the first chamber.

6. The fluid chamber assembly of claim 1, wherein the at least one perforation includes a plurality of perforations.

7. The fluid chamber assembly of claim 1, wherein the at least one perforation has a conical profile.

8. The fluid chamber assembly of claim 1, wherein the fluid chamber assembly is configured to be installed in a vehicle, such that the first chamber defines an upper chamber and the second chamber defines a lower chamber.

9. The fluid chamber assembly of claim 1, wherein a fluid inlet is defined on a bottom surface of the housing and the at least one de-aeration opening is defined on an opposite, top surface of the housing, and the barrier is curved upwards towards the at least one de-aeration opening and away from the fluid inlet.

10. The fluid chamber assembly of claim 9, wherein the at least one perforation has a conical profile that tapers from a first larger opening to a second smaller opening.

11. The fluid chamber assembly of claim 9, wherein a switching solenoid valve inlet is defined on the bottom surface of the housing.

12. The fluid chamber assembly of claim 1, wherein a diameter of the at least one perforation is greater than a diameter of the at least one de-aeration opening.

13. A fluid chamber assembly comprising:
a medium pressure chamber defining at least one de-aeration opening; and
a barrier within the medium pressure chamber that divides a housing into an upper chamber and a lower chamber,
the barrier defining a plurality of perforations each having a conical profile, and the barrier has a curved profile that is convex upwards towards the upper chamber,
the upper chamber is connected to the at least one de-aeration opening, and the lower chamber is connected to a fluid inlet and a solenoid switching valve inlet that is connected to a high pressure chamber.

14. The fluid chamber assembly of claim 13, wherein the upper chamber is smaller than the lower chamber.

15. The fluid chamber assembly of claim 13, wherein the plurality of perforations includes at least twenty perforations.

16. A method of supplying de-aerated fluid to a switching solenoid valve via a fluid chamber assembly, the method comprising:
providing a fluid chamber assembly including a housing defining an interior and at least one de-aeration opening;
positioning a barrier within the interior of the housing to divide the interior into first chamber and a second chamber, the barrier defining at least one perforation, and the second chamber being connected to a fluid inlet and a switching solenoid valve inlet;
supplying fluid to the second chamber via the fluid inlet;
de-aerating the fluid via passage of air bubbles through the at least one perforation and out of the at least one de-aeration opening; and
supplying de-aerated fluid to the switching solenoid valve inlet.

17. The method of claim 16, wherein the at least one perforation includes a plurality of perforations.

18. The method of claim 16, wherein the at least one perforation has a conical profile.
